(19) United States
(12) Patent Application Publication
(10) Pub. No.: US 2018/0122030 A1
(43) Pub. Date: May 3, 2018

(54) EMERGENCY AUTOMATED GUNSHOT LOCKDOWN SYSTEM

(71) Applicant: Security USA Services, LLC, Albuquerque, NM (US)

(72) Inventors: Boaz Raz, Albuquerque, NM (US); Jennifer E. Russell, Albuquerque, NM (US)

(73) Assignee: Security USA Services, LLC, Albuquerque, NM (US)

(21) Appl. No.: 15/342,313

(22) Filed: Nov. 3, 2016

(51) Int. Cl. G06Q 50/26; H04M 3/51; G08B 17/08; G08B 13/196; G05B 19/042

(52) U.S. Cl. CPC G06Q 50/265; H04M 3/5116; G05B 2219/24024; G08B 13/1963; G05B 19/0428; G08B 17/08

(57) ABSTRACT

The Emergency Automatic Gunshot Lockdown System (EAGL) detects gunfire, and executes at least one predetermined lockdown scenario, such as notifying law enforcement of an active shooter, locking down soft target areas, and alerting building occupants of an active shooter situation. Once a firearm is discharged, the gunshot detection sensors send “real time” data to building officials, law enforcement, and building occupants notifying them of an active shooter situation. Simultaneously, predetermined commands are sent to perimeter, office, classroom, and other soft target areas to lockdown and stay secure, to keep the shooter from entering these soft target areas, and to prevent shooter from entering other buildings.

### BACKGROUND OF THE INVENTION

### Field of the Invention (Technical Field)

The claimed invention relates to door lockdown systems, and more particularly, to a system and method that combines door locking technology, gunshot detection technology, and the control software for operating the system.

### Background Art

Historically, in the event of an active shooter, the majority of violence occurs in the first five minutes of the event. Usually, it takes ten minutes or more for law enforcement to arrive on the scene. Law enforcement arrives on the scene with scant information and are sometimes ambushed and killed by the deranged shooter.

Other systems that detect gunshots are connected to a monitoring station, which depends on a monitored building authority, and the human operator notifying an administrator of the gunshot situation, which will require a manual activation of the emergency system. Other gunshot detecting systems are triggering video feed from the location where the event is taking place; however, the lockdown sequence is manually activated.

Some approaches require the room occupant, usually the teacher, to lock the classroom door or exterior door manually. There is electronic access control, but that would still require a person to actuate the system should an active shooter start firing inside or outside a school. The problem with the manual approaches is that it relies on people to perform the task, and it takes a few minutes for the message to propagate to the affected area and take action. Another disadvantage is the high cost of such a system.

These state of the art approaches are not automated and require human response to actuate the system or lock a door, and there is too much time lost. These notification systems are sluggish and sometimes inaccurate. Thus, today this function is being performed manually, and it relies on the people to be at the right place at the right time.

### SUMMARY OF THE INVENTION (DISCLOSURE OF THE INVENTION)

The Emergency Automated Gunshot Lockdown (hereinafter “EAGL”) system is designed to force the automatic lockdown of the doors in the event of an active shooter, and send notifications to law enforcement with real time data including shooter imagery, GPS locations, and weapon ballistic data with great accuracy and detail.

The EAGL system is a fully automated system. It locks the doors in seconds therefore containing the perpetrator in a certain area, and buys the people in the area time to escape or execute other lifesaving actions. The EAGL also automatically calls authorities and other building security notifying them of an active shooter situation including shooter imagery, GPS location of the shooter, along with weapons ballistics data. EAGL also displays in real time, the location of the shooter and activates the public address system with the emergency messages, and streams the closest camera video to the security control room monitor. All this is done in a matter of seconds with no human intervention, therefore, not subject to human error.

The primary advantage of this system is that it detects gunfire, notifies law enforcement of the presence of a shooter, and gathers critical data such as GPS location and imagery of the shooter as well as ballistic data of the event. It locks down classrooms and perimeter doors to deter a shooter from entering, and it sends alerts and emergency messaging through the PA system to notify building occupants of an active shooter.

Further advantages are that building occupants are protected by an automatic lockdown to keep the shooter out, then law enforcement is given real time data so they are able to provide adequate and immediate response to an active shooter without becoming a victim. Then, building occupants are given critical lifesaving information within seconds of an active shooter situation giving them situational awareness to make life saving decisions and movement away from the violence.

Other or related systems, methods, features, and advantages of the invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated into and form a part of the specification, illustrate several embodiments of the presently claimed invention and, together with the description, serve to explain the principles of the presently claimed invention. The drawings are only for the purpose of illustrating a preferred embodiment of the presently claimed invention and are not to be construed as limiting the presently claimed invention. In the drawings:

FIG. 1 shows a typical EAGL system.

FIG. 2 is a flow chart showing a method of the system operation.

FIG. 3A is a flow chart showing a scenario building program.

FIG. 3B is a continuation of the flow chart of FIG. 3A.

FIG. 3C is a continuation of the flowchart of FIG. 3B.

FIG. 4 shows an example of a multiple building scenario.

FIG. 5 shows a display of a building in a normal mode.

FIG. 6 shows a display of a building in an active shooter event.

### DESCRIPTION OF THE PREFERRED EMBODIMENTS

### Best Modes for Carrying Out the Invention

As utilized herein, terms such as “about”, “approximately”, substantially, and “near” are intended to allow some leeway in mathematic& exactness to account for tolerances that are acceptable in the trade. Accordingly, any deviations upward or downward from the value modified by the terms “about”, “approximately”, “substantially”, or “near” in the range of 1% to 20% or less should be considered to be explicitly within the scope of the stated value.

As used herein, the term “software” includes source code, assembly language code, binary code, firmware, macro-instructions, micro-instructions, or the like, or any combination of two or more of the foregoing.

The term “memory” refers to any processor-readable medium, including but not limited to, RAM, ROM, EPROM, PROM, EEPROM, disk, floppy disk, hard disk, CD-ROM, DVD, or the like, or any combination of two or more of the foregoing, on which may be stored a series of software instructions executable by a processor.

The terms “processor” or central processing unit “CPU” refer to any device capable of executing a series of instructions and includes, without limitation, a general or special-purpose microprocessor, finite state machine, controller, computer, digital signal processor (DSP), or the like.

The term “logic” refers to implementations of functionality in hardware, software, or any combination of hardware and software.

The EAGL software integrates with a gunshot detector and an access control system that have a real time lockdown capability. The EAGL will automatically execute one or more preprogrammed scenarios that were entered into the system based on the specific customer security strategy.

The EAGL system also integrates with existing security systems such as an IP camera system, PA system, and phone dialer, as well as security command and control centers. It will manage multiple buildings based on the preprogramed scenarios.

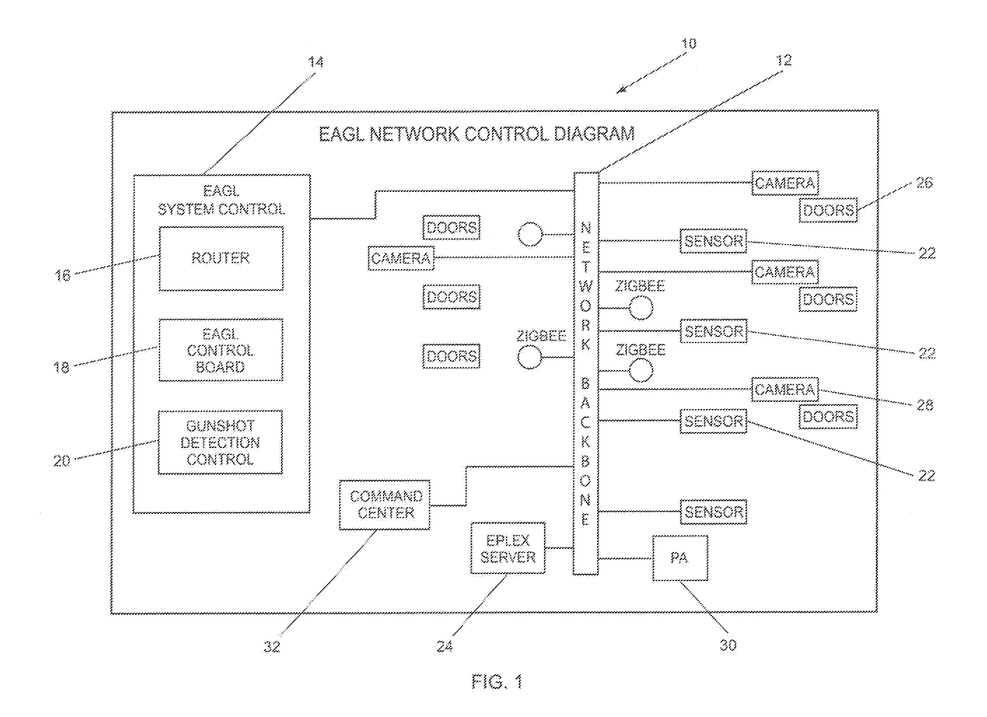

FIG. 1 is a high level depiction of a typical EAGL system 10. The components include a network backbone 12 connected to each of the other components providing for two-way communication. The connection can be wired, wireless or a combination of the two. EAGL system control 14 typically includes router 16, EAGL control board 18 and gunshot detection control 20. Router 16 provides for communication from the EAGL system control 14 to network backbone 12. EAGL control board 18 provides for router 16 and gunshot detection control 20 which communicates with sensors 22 strategically placed in the building to be protected, whereby sensors 22 detect gunshots, such as detecting muzzle blasts and/or shockwaves from a projectile. Sensors 22 can also provide time and direction of the gunshot. Central Processing Unit (CPU) 24, such as an Eplex server, provides for the receipt of data from sensors 22, and automatically triggers responsive measures. A plurality of scenarios can be entered into CPU 24 that correspond to user defined parameters. These can include, but are not limited to, a building layout, number of doors, location of the detected gunshot, whether the area is populated, and the like. Once one or more gunshots are detected the preferred scenario(s) is automatically implemented, This can include locking doors 26 to contain one or more intruders, initializing audio/visual systems 28, initializing prerecorded announcements over a PA system 30, notifying law enforcement, and communicating and providing status information to command center 32 as discussed in detail below.

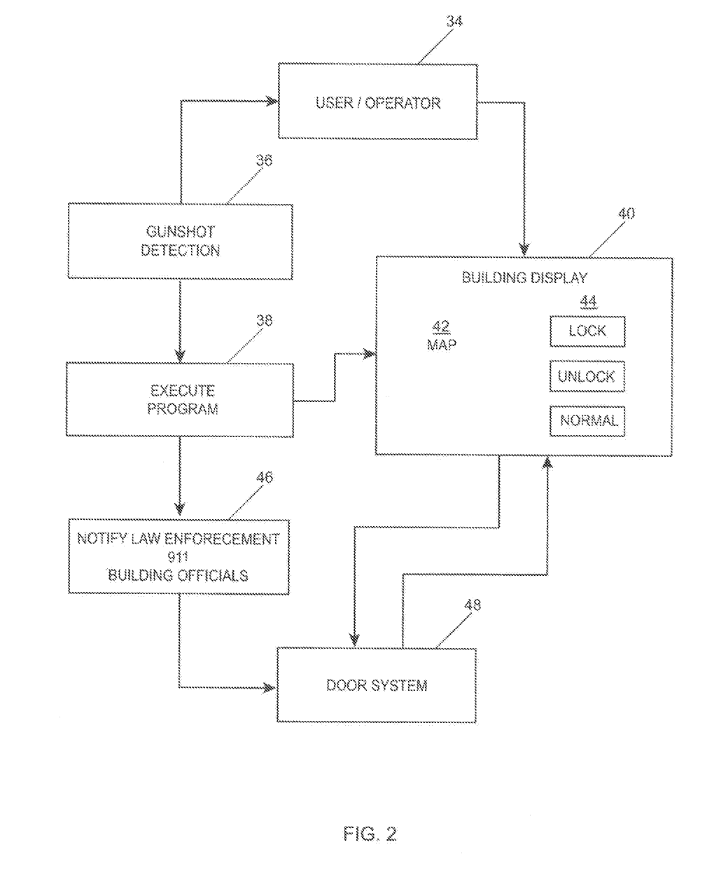

FIG. 2 is a flow chart exhibiting the preferred method for the EAGL system. In addition to gunshot detection 36 for triggering a lockdown scenario via execute program 38, user/operator 34 can manually trigger a programmed scenario via execute program 38. User/operator command is sent to control center where building display 40 provides for maps 42, lock status 44, and other pertinent information. User/operator 34 is able to lockdown or open any doors in the facility, and can view real time door status via building display 40. Preferred building display 40 shows a building map as well as each door location and its status, for example, a color red indicating a locked door and the color green indicating an unlocked door. If gunshot detection 36 executes program 38 this information is sent to building display 40 for status information. Along with providing status information execute program 38 notifies law enforcement by dialing 911 and/or notifies building officials 46. Simultaneously, door systems 48 are locked pursuant to the programmed scenarios and sent to building display 40 for status information. In the manual mode, if user/operator 34 manually triggers a scenario, the door system 48 locks specific doors to contain the shooter in a specific area. Once a manual trigger is initiated, for example by a lockdown button being depressed, or a gunshot detected, the EAGL will execute the scenarios that were programed based on the specific area where the intruder is physically located or the location of the detected gunshot.

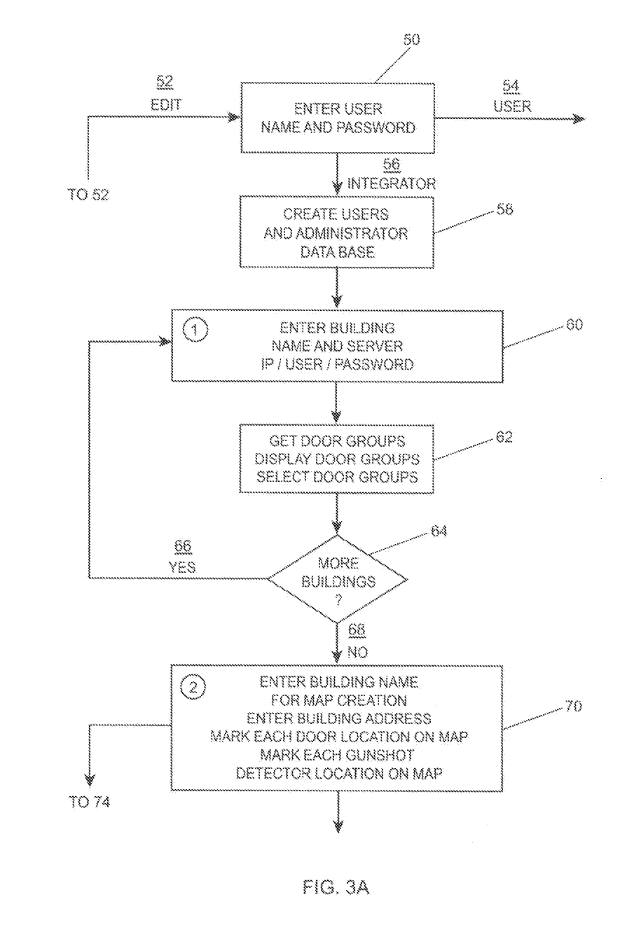

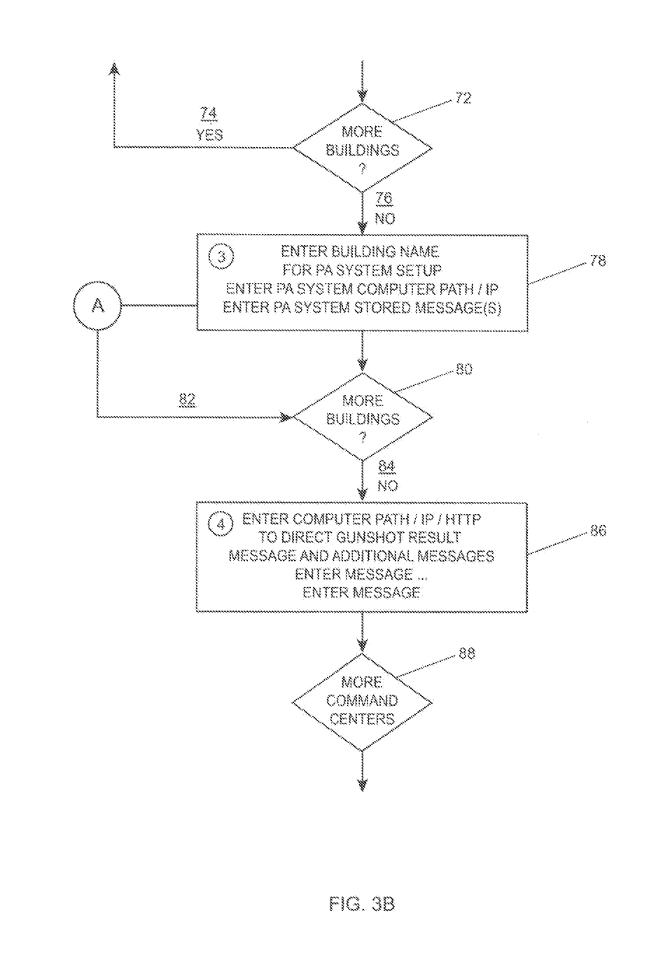

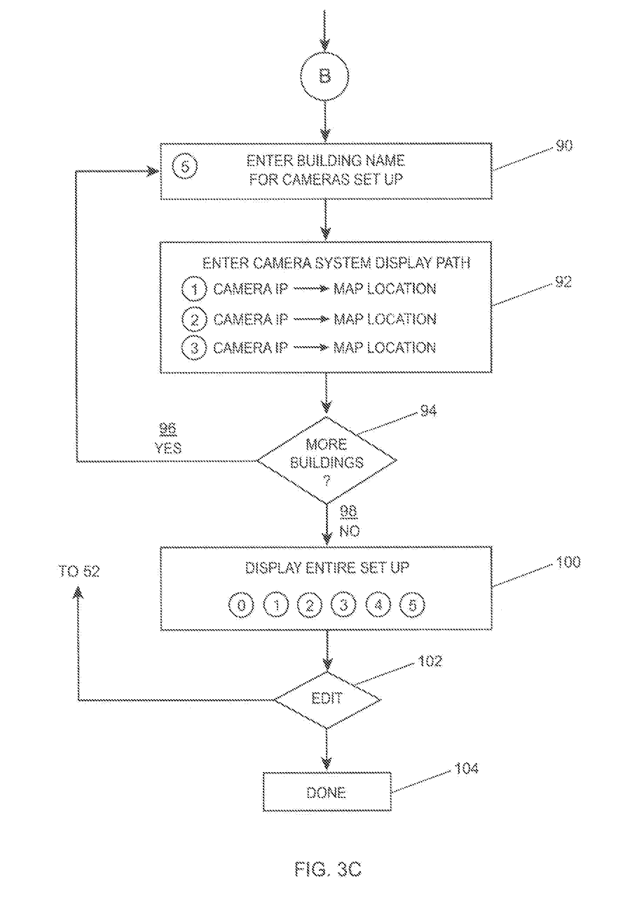

FIGS. 3A, 3B, and 3C are a three-part flow chart showing the preferred method for programming the lockdown scenarios for implementation upon a triggering event for a specific building implementation. This method describes the preferred method; however, one or more systems can be added or deleted depending on the components contained in the subject buildings. For example, if the building does not have a PA system, the system can still be used, but there will be no public announcement. In another example, the system can also trigger items such as flashing lights, smoke dispersion, distracting audio noises, and the like. This disclosure is intended to include these variations.

In order to access the system, a user name and password are entered 50. This presupposes the creating of a user name and password (not shown). User name and/or password can be edited 52 by user 54. The scenario planning and programming can only be accessed by an administrator (not user) privileged in this preferred method. This information is fed to integrator 56 to create users and administrator database 58. Database 58 is populated with building name, server IP, user name, and password 60. For each customer location and budding name, the access control server IP is preferably entered. Next, door groups 62 are selected and entered and can also be displayed. EAGL will import all the door groups 62 that are defined in CPU 24, and will allow the user to choose a door group 62 or multiple door groups to be locked during a lockdown in a building. If there are more buildings 64 a “yes” feedback loop 66 takes the administrator back to step 60 to enter the next building information. This can be repeated until all of the subject buildings are entered. If there are no further buildings 68, the next step is to create a map 70, which preferably contains a building name, address, door location for each building, and a location of each sensor or gunshot detector in each building. In a preferred system, once the building address is entered, the EAGL displays a google map of that building. The administrator can center the building at the center of the display area and will size it accordingly. The administrator preferably selects from the list of the door names, and drags and places them on the building map in its appropriate location. He/she can also place the gunshot detectors on the map. If there are more buildings 72 a feedback loop 74 repeats step 70 until all of the building door and gunshot detectors are mapped.

Once there are no further buildings for entry 76, a building name and PA system information 78 is entered. This administration program can include a PA system computer path/IP address, and entry of the message or messages for storage and broadcast for the different scenarios. If there are more buildings 80, a feedback loop 82 requests additional building PA system setups 78 until no further building PA systems 84 exist.

Next, the administrator enters a computer path to direct gunshot data or results for display or additional messages to be broadcast after gunshot detection 86. This data can be sent to more or other command centers 88.

The administrator then enters the building name for each gunshot detector location, and the IP address of the nearest camera 90 for set up to that sensor in each building. Each camera display path is entered with camera IP and map location 92 for that building. If there are further buildings 94, feedback loop 96 allows for further camera setups 90 until all buildings are included and no other building needs entry 98. Next, ail camera setups are displayed 100 and the administrator can edit 102 any of the previous entries to optimize the system until complete 104.

Another feature that can be included in the administrator programing is a dialer with emergency 911 and building security office and management to alert them of a manual or gunshot trigger of the system (not shown).

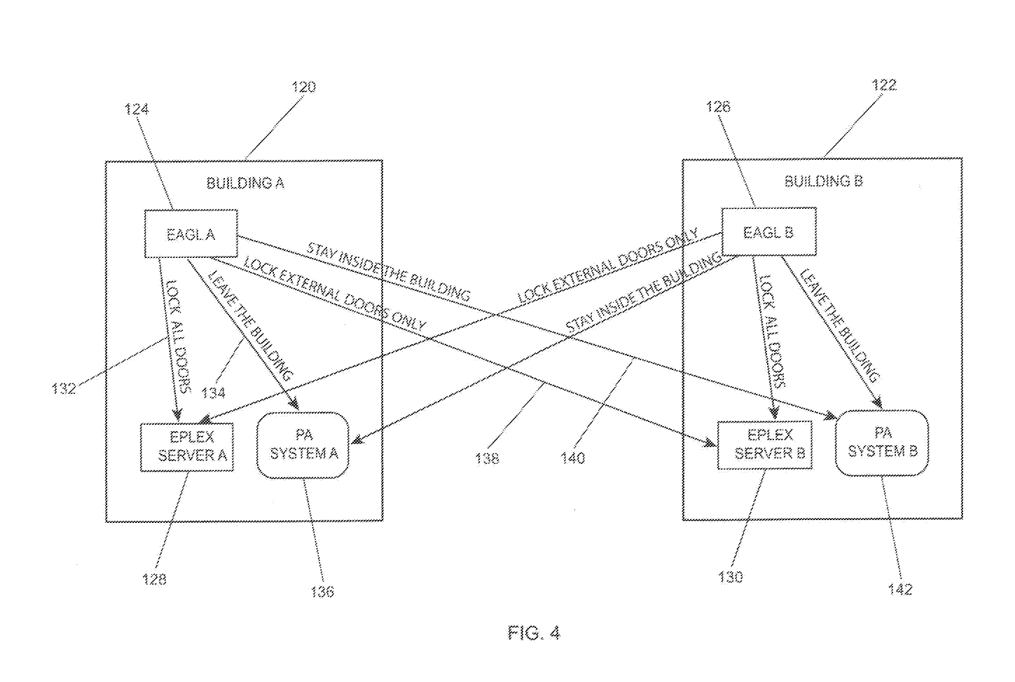

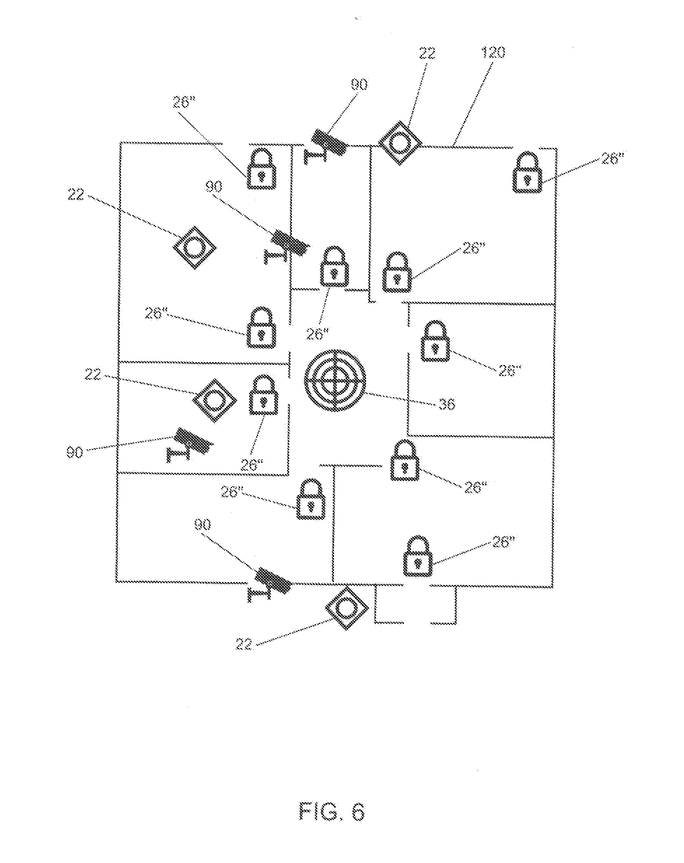

A unique feature of the presently claimed invention is the dynamic creation and selection of scenarios for triggering in the event of an active shooter, or the like. FIGS. 4, 5, and 6 along with FIG. 2 illustrate the system to create and select scenarios for active shooter events. FIG. 4 is an example of a two building scenario. Although the example illustrates only two buildings, this disclosure specifically includes multiple buildings, which can use the same components and steps as set forth in the example. In this example, there is building A 120 and a Building B 122 on the same location. Building A 120 has an EAGL controller A 124 along with EPLEX server A 128 and building B 122 has EAGL controller B 126 along with EPLEX controller B 130. In an active shooter event in building A 120, EAGL controller A 124 sends a lock all doors command 132 to EPLEX sower A 128 and a leave the building message 134 to PA system A 136. Simultaneously, EAGL controller A 124 sends a lock external doors command 138 to EPLEX server B 130 and a stay inside building message 140 to PA system B 142. The inverse scenario can take place when an active shooter event is detected in building B 122.

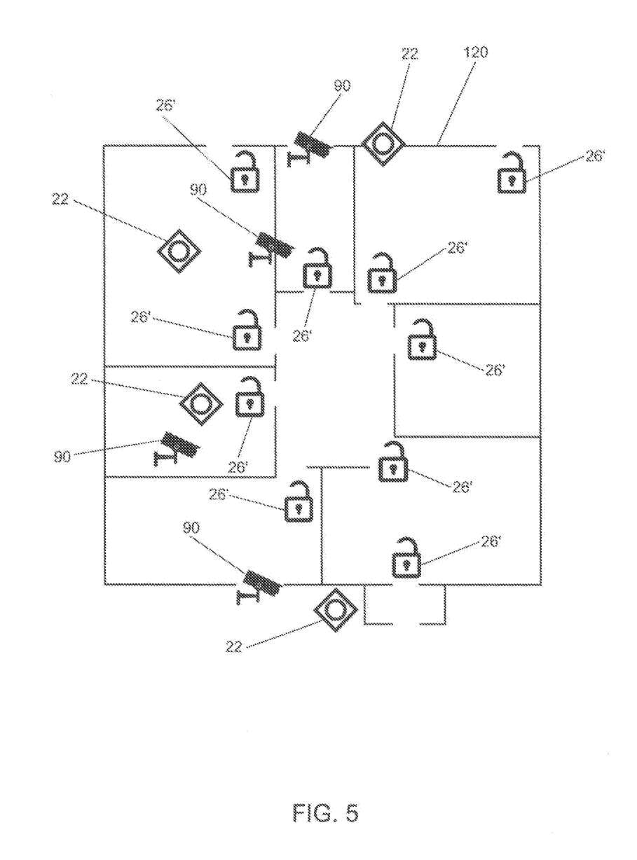

FIG. 5 shows a display of single building 120 in a normal status. Each door in the buildings has an electronically controlled lock 26, and the locks are controlled by one or more EAGL controllers. In this display, unlocked doors 26′ are depicted as an open lock and locked doors 26″ are depicted as a closed lock. FIG. 5 shows a building display in a normal mode. A preselected number of doors are unlocked 26′ during normal operational mode to allow building access during normal business hours. Some doors can be locked to restrict access. (Not shown). Gunshot detectors or sensors 22 are strategically placed inside of building 120 so that a location can be determined by triangulation, or similar manner based on the sensor data Audio/visual systems or cameras 90 are also strategically placed in building 120 so that they can be pointed, either automatically or manually towards a location of a detected gunshot.

For this example, assume a shot is fired and is detected by gunshot detectors 22 and a gunshot location 36 is automatically determined in building A 120. In this scenario, all of the doors are automatically locked 26″ and at least one of the closest cameras 90 are aimed towards the located gunshot 36. In this scenario, if the intruder is contained by locked doors 26″, other doors in the building can be opened to allow legal building occupants to exit the building. (Not shown).

As shown in the figures the EAGL response can be programmed as follows:

1. Lock all the doors 26″ in Building A 120 (the preferred system exit is always allowed).

2. Lock all the external doors 26″ in Building B 122.

3. Show the map door lock status 26 on a building display 40, and show on the map the location and coordinates of the shooter 140.

4. Display across the EAGL screen 40 location 36, a time and the caliber weapon was used.

5. Call 911 46 and the rest of the building officials letting them know that gunfire was detected at building A 120.

6. Send e-mail, text, and mass notification messages 142.

7. Direct the closest camera 28 to the shooter and display that information on the EAGL display 40.

8. Activate the PA systems 30 in Building A 120 and B 122, and send the appropriate messages to Building A and B's PA system. The preferred message transmitted in Building A 120 can be “evacuate the building” and the preferred message broadcast in Building B 122 can be “stay inside the building”.

Many of these steps are in the alternative, meaning that they can be omitted or expanded, depending on the site layout and building use. A different scenario is then programmed for a different part of Building A and also for the differing portions of Building B and Building N (next). These scenarios are preprogrammed into EPLEX servers 24 and are automatically selected and implemented depending on the location of the shot detection.

When a gunshot is detected, the EAGL will execute the scenarios that were programmed per building, lock the programmed doors per building, and display the shooter location. It will then send preselected PA messages, display the video stream of the camera at the location, and alternatively dial 911 and all other programmed numbers. The preferred software is running on a Linux based computer that allows the execution of the scenarios in a very short period of time and it is functional twenty-four hours a day, seven days a week.

The new features are the broad integration of this system with multiple external systems and the ability to control access and control doors remotely. The traditional way of locking down buildings manually by humans would not provide instant lockdown or precious time needed for building occupants to escape and survive an active shooter. The presently claimed system response time is approximately twenty seconds from the time the gunshot is detected to the time the door is locked and law enforcement notified.

Although the presently claimed invention has been described in detail with particular reference to these preferred embodiments, other embodiments can achieve the same results. Variations and modifications of the presently claimed invention will be obvious to those skilled in the art and it is intended to cover all such modifications and equivalents. The entire disclosures of all references, applications, patents, and publications cited above, are hereby incorporated by reference.

What is claimed is:

1. A method comprising:
providing a plurality of predetermined sequences of security measures for differing scenarios of an active shooter event;
detecting a gunshot;
automatically activating at least one predetermined security measure upon detection of the gunshot and a location of the detected gunshot, wherein the predetermined security measures comprise locking a predetermined number of doors.

2. The method of claim 1 wherein the step of providing a plurality of predetermined sequences is based on user defined parameters comprising a building layout, a number of doors, a location of the detected gunshot and whether the building is populated.

3. The method of claim 1 wherein the step of locking a predetermined number of doors comprises preventing the active shooter from exiting from a predetermined area.

4. The method of claim 1 further comprising providing location coordinates of the detected gunshot.

5. The method of claim 4 further comprising directing at least one camera towards the location coordinates.

6. The method of claim 1 wherein the predetermined security measures further comprise mapping a status of all doors in one or more buildings, automatically calling 911 advising of the detection, notifying subscribed mobile devices of the detection, and activating a public announcement (PA) system with a preprogramed announcement.

7. A non-transitory computer-executable storage medium comprising program instructions which are computer-executable to implement an automatic lockdown system comprising:
program instructions that cause entry of a plurality predetermined sequences of security measures for differing scenarios of an active shooter event;
program instructions that cause a detection of a gunshot;
program instructions that cause an automatic activation of at least one predetermined security measure upon detection of the gunshot and a location of the detected gunshot, wherein the predetermined security measures comprise locking a predetermined number of doors.

8. The non-transitory computer-executable storage medium of claim 7 wherein the program instructions that cause the entry of a plurality of predetermined sequences is based on user defined parameters comprising a building layout, a number of doors, a location of the detected gunshot and whether the building is populated.

9. The non-transitory computer-executable storage medium of claim 7 wherein the program instructions that cause a predetermined number of doors to be locked comprises preventing the active shooter from exiting from a predetermined area.

10. The non-transitory computer-executable storage medium of claim 7 further comprising program instructions that cause location coordinates of the detected gunshot be provided.

11. The non-transitory computer-executable storage medium of claim 10 further comprising program instructions that cause at least one camera be directed towards the location coordinates.

12. The non-transitory computer-executable storage medium of claim 7 wherein the predetermined security measures further comprise program instructions to map a status of all doors in one or more buildings, to automatically call 911 advising of the gun shot detection, to notify subscribed mobile devices of the detection, and to activate a public announcement (PA) system with a preprogramed announcement.

13. A system for locking down a facility, comprising;
one or more Central Processing Units (CPU's) configured to enter and store a plurality of predetermined door locking scenarios;
one or more gunshot detecting units;
one or more system control units couple to the one or more CPUs and the one or more gunshot detecting units configured to automatically initiate a predetermined scenario from the plurality of scenarios in response to signals generated by the one or more gunshot detecting units; and
one or more door locking units configured to automatically lock one or more predetermined door locks based on signals from the one or more system control units.

14. The system of claim 13 wherein the plurality of predetermined door locking scenarios are based on user defined parameters comprising a building layout, a number of doors, a location of the detected gunshot and whether the building is populated.

15. The system of claim 13 wherein the CPU's and system control units are configured to preventing the active shooter from exiting from a predetermined area.

16. The system of claim 13 wherein the CPU's and system control units are configured to provide location coordinates of the detected gunshot.

17. The system of claim 16 wherein the CPU's and system control units are configured to direct at least one camera towards the location coordinates.

18. The system of claim 13 wherein the predetermined scenarios further comprise mapping a status of all doors in one or more buildings, automatically calling 911 advising of the gun shot detection, notifying subscribed mobile devices of the detection, and activating a public announcement (PA) system with a preprogramed announcement.
